(19) United States
(12) Patent Application Publication
(10) Pub. No.: US 2017/0215462 A1
(43) Pub. Date: Aug. 3, 2017

(54) FINE FLAVORS GRINDABLE PARTICLES

(71) Applicant: FIRMENICH SA, Geneva 8 (CH)

(72) Inventor: Pierre-Etienne BOUQUERAND, Geneva (CH)

(73) Assignee: Firmenich SA, Geneva 8 (CH)

(21) Appl. No.: 15/500,786

(22) PCT Filed: Jul. 28, 2015
(86) PCT No.: PCT/EP2015/067276

§ 371 Date: Jan. 31, 2017

Related U.S. Application Data
(60) Provisional application No. 62/031,858, filed on Aug. 1, 2014.

(51) Int. Cl. A23L 27/00; A23P 30/20; A47J 42/00

(52) U.S. Cl. CPC A23L 27/72; A47J 42/00; A23P 30/20; A23V 2002/00

(57) ABSTRACT

Provided herein is a method of flavouring a food comprising grinding a flavour bead onto a food or beverage prior to or contemporaneous with the use of the food or beverage, wherein the particle is in the form of an extruded, glassy bead, comprising a fibrous carrier composition encapsulating a flavour ingredient or composition active ingredient, characterised in that the bead has a cross-section diameter comprised between 3 mm and 15 mm. Further provided here is a flavour mill comprising the bead. The particle or bead comprises an encapsulating carrier composition essentially made of fibrous materials, which are both sugarless and non-cariogenic and an encapsulant, such as a flavour material.

### FIELD

An embodiment provided herein relates to the field of encapsulation. It concerns more particularly a novel delivery system capable of releasing an active ingredient such as a flavour and wherein a novel encapsulating carrier composition which is essentially made of fibrous materials, and more particularly of a combination of two particular fibrous polysaccharides enables the preparation, through an extrusion process, of large glassy beads wherein said particles can be delivered to a food or beverage using a grinder.

### BACKGROUND

The literature discloses the grinding for example of pepper corns and salts. Also described is the grinding of engineered flavour particles.

### SUMMARY

Provided herein is a method of flavouring food comprising grinding a particle on top of a food or beverage contemporaneous with the use of the food or beverage, wherein the particle is in the form of an extruded, glassy bead, comprising a fibrous carrier composition encapsulating a flavour ingredient or composition active ingredient, characterised in that the bead has a cross-section diameter comprised between 3 mm and 15 mm, and the carrier composition comprises from 1 to 70% by weight of a first water-soluble fibrous polysaccharide having an average molecular weight higher than 10000 Dalton and an average degree of polymerisation higher than 60, and from 1 to 80% of a second water-soluble fibrous polysaccharide having an average molecular weight below 10000 Dalton and an average degree of polymerisation below 60, said percentages being defined by weight relative to the total weight of the carrier composition.

An embodiment provided herein relates to a novel particulate composition in the form of a large glassy bead made of an essentially fibrous carrier composition.

### DETAILED DESCRIPTION OF THE DRAWINGS

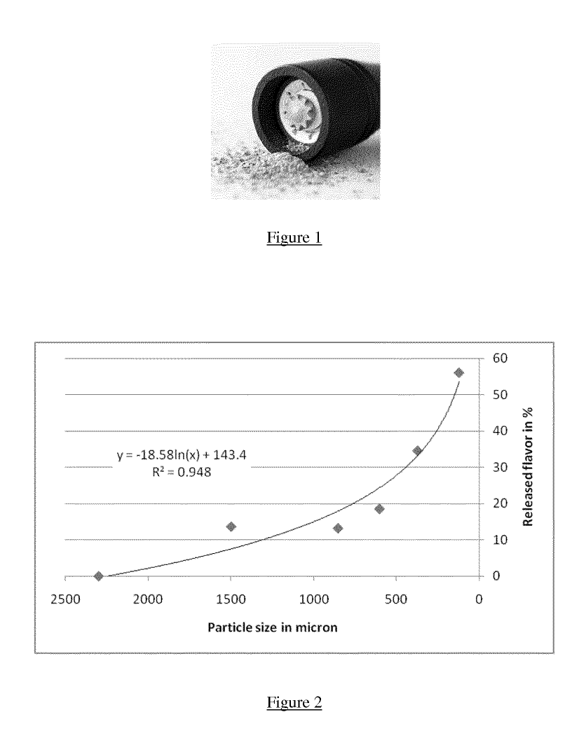

FIG. 1 is a photograph of A particular mill suitable for use for grinding beads herein is a ceramic based and adjustable CrushGrind.

FIG. 2 shows the release rate of a flavour from ground beads graphed against the ground particle size wherein the load of the flavour is about 6.7% by weight of the total weight of the beads.

### DETAILED DESCRIPTION

Also provided herein is a particulate composition in the form of an extruded, glassy bead, comprising a fibrous, carrier composition encapsulating an active ingredient, wherein the bead has a cross-section diameter comprised between 3 mm and 15 mm, preferably between 5 mm and 15 mm, more preferably between 6 mm and 15 mm and is preferably spherical. The size of the bead is linked to its characteristic carrier composition, which is essentially made of water-soluble fibrous materials, and which comprises more particularly one long-chain water-soluble fibrous polysaccharide and another fibrous material of lower molecular weight. The specific choice of water-soluble fibres constituting the carrier composition of the product and defined below by their respective average molecular weights and degrees of polymerisation allows, through an extrusion process, to provide a significant relaxation phenomenon of the polymeric carriers at the end of the die of the extruder, leading to, for example, spherical beads with a diameter larger than 3, preferably larger than 4, more preferably larger than 5 mm and even more preferably larger than 6 mm. On the other hand, the nature of the fibrous materials advantageously imparts to the final product qualities such as non-cariogenicity and sugarless nature, which render it particularly useful for the preparation of specific products of the sweet and savoury confectionery area and bakery area, or for an use as a traditional delivery system for flavour or other active ingredients, when added to a ready-to-consume end product.

The size of the delivery systems gives an appreciated visual effect in the final application, while providing an efficient protection of the volatile and labile ingredient encapsulated and a controlled release of the latter, i.e. a release occurring only at the time of consumption of the end product. In other words, the products are used in applications both for their qualities as efficient delivery systems and for their visual aspect which differs from usually used encapsulated systems.

Other benefits and advantages of the product will become apparent through the detailed description and the examples given below.

The particulate composition is in the form of an extruded, glassy bead, comprising a fibrous carrier composition encapsulating an active ingredient, wherein the bead has a cross-section diameter comprised between 3 mm and 15 mm, preferably between 5 mm and 15 mm, more preferably between 6 mm and 15 mm and the carrier composition comprises from 1 to 70% by weight of a first water-soluble fibrous polysaccharide having an average molecular weight higher than 10,000 Dalton (Da) and an average degree of polymerisation higher than 60, and from 20 to 99% of a second water-soluble fibrous polysaccharide having an average molecular weight below 10,000 Da and an average degree of polymerisation below 60, percentages being given by weight relative to the total weight of the carrier composition.

The term water-soluble polysaccharide means that the polysaccharide is at least 50% soluble according to the method described by L. Prosky et al., J. Assoc. Off. Anal. Chem. 71, 1017-1023 (1988). As was mentioned before, the term fibre or fibrous polysaccharide refers to the fact that the polysaccharide cannot be digested or hydrolysed by the endogenous secretions of the human digestive tract. Accordingly, the term non-fibrous polysaccharide means that the polysaccharide can be digested by the endoenuous secretions of the human digestive tract.

The particulate composition comprises a specific encapsulating carrier which is essentially made of fibres. The term “carrier”, also referred to as “matrix”, is commonly used in the encapsulation art to designate the encapsulating composition in a delivery system, i.e. the composition wherein the active ingredient to be protected is entrapped. While fibrous materials have sometimes been mentioned as being possibly added to an encapsulating composition, in particular to control the release of the encapsulant.

The first water-soluble polysaccharide present in the carrier or encapsulating composition of the product is a soluble fibre having an average molecular weight higher than 10,000 Dalton (Da) and an average degree of polymerisation higher than 60. This long-chain polymer is present in proportions varying between 1 and 70% by weight, relative to the total weight of the carrier composition, preferably between 2 and 50%, more preferably between 8 and 20% by weight, for example between 2and 20% by weight, even more preferably about 5 to about 15% by weight In a particular embodiment, it is chosen from the group consisting of konjac mannan, xanthan, gum Arabic, guar gum, pectin, locus bean gum, soluble soyabean polysaccharide, beta-glucan, sugar-agar and alginate.

The second water-soluble polysaccharide present in the carrier composition of the bead is a fibre with a smaller molecular weight. In particular, the latter has an average molecular weight below 10,000 Da and an average polymerisation degree below 60. Typically, it is selected from the group consisting of a dextrin and a fructo oligo saccharide (FOS). It is comprised in proportions varying between 20 and 99%, for example, between 30 and 99%, by weight and preferably between 50 and 98%, for example between 80 and 98% by weight relative to the total weight of the carrier composition. A particularly suitable dextrin has a Chemical Abstract Registry Number of 9004-53-9. This material is commercially available from Roquette Freres as Nutriose FB®, marketed as a new soluble dietary fibre offering good digestive tolerance, acid and heat resistance, and bulking effect for sugar-free products. A particular FOS is inulin.

In a particular embodiment, the carrier composition comprises less than 20 wt. % of non-fibrous polysaccharides, more preferably less than 10 wt. %, even more preferably less than 5 wt. % of non-fibrous polysaccharides. Most preferably, it is free of non-fibrous polysaccharides.

In a particular embodiment, the first and/or the second polysaccharide are non-cariogenic. More preferably, both polysaccharides are non-cariogenic.

In one embodiment provided herein, the carrier composition is sugarless and/or non-cariogenic.

In a particular embodiment, the carrier composition has a low glycemic index, that is a glycemic index below 55. More preferably, the glycemic index of the carrier composition is below 40, most preferably it is below 25.

In addition to components described above of the encapsulating material, the carrier may comprise a plasticizer, typically in proportions varying between 1 and 10% by weight relative to the total weigh of the particulate composition. Plasticizers commonly used in extrusion techniques are well known to a person skilled in the art. They include, while not being limited to, water, propylene glycol, isomalt, glycerol, ethylene glycol, dipropylene glycol, triacetin, organic acids and mixtures thereof.

The carrier composition can also comprise optional ingredients, such as colorants or emulsifiers. Typical examples of emulsifiers include lecithin, citric esters of fatty acids, but other suitable emulsifiers are cited in reference texts such as Food emulsifiers and their applications, 1997, edited by G. L. Hasenhuettl and R. W. Hartel. A more detailed description of these ingredients is not necessary in the present case as these ingredients are commonly used during the extrusion of any carrier composition and are well known by a skilled person in the art. The amount of emulsifier is particularly provided in an amount of about 0.4 up to about 2%, more particularly at about 5% by weight of the total weight of the particle.

The carrier composition further comprises about 0% up to about 4%, more particularly about 0.5% to about 2%, more particularly about 1.6% by weight, of the total weight of the particle, of a lubricant selected from the group consisting of monoglycerides, diglycerides, and triglyceridess. More particular the triglyceride may be a medium chain triglycerides. Even more particularly the MCT may be caprylic/capric triglyceride such as Neobee®5 MCT.

The total amount of the carrier with respect to the relative amounts of the components, does not take into account the amount of added water.

Lubrication by the mean of surfactant/triglyceride mixture was found compulsory in a process to avoid bubble growth of volatiles compound (water and/or flavours) within the extrudate due to uncontrolled shear stress. A typical lubricant for extrusion is a 50/50 mixture of lecithin and medium chain triglycerides.

The carrier composition encapsulates an active ingredient preferably comprised in proportions varying between 0.01 and 15% by weight, more preferably between 0.05 and 3% by weight, relative to the total weight of the particulate composition. The active ingredient protected in the delivery system can be as varied as flavours, fragrances, vitamins, drugs or colouring materials, for example. In one embodiment, the active ingredient is selected from the group consisting of a flavour, a fragrance, a vitamin, a drug, a colorant, a nutraceutical, a whitening agent, an antibacterial agent, and a mixture comprising at least two of these. The active ingredient may be a volatile or a labile component which may be in liquid or solid form. In a particular embodiment, the active ingredient is hydrophobic. For example, it is a flavour or fragrance ingredient or composition. The terms “flavour or fragrance ingredient or composition” as used herein are deemed to define a variety of flavour and fragrance materials of both natural and synthetic origin. They include single compounds and mixture. Specific examples of such components may be found in the current literature, e.g. in Perfume and Flavour Chemicals by S. Arctander, 1969, Montclair N.J. (USA); Fernaroli's Handbook of Flavour Ingredients, 1975, CRC Press or Synthetic Food Adjuncts, 1947, by M. B. Jacobs, van Nostrand Co., Inc and are well known to the person skilled in the art of perfuming, flavouring and/or aromatising consumer products, i.e. of imparting an odour and/or a flavour or taste to a consumer product traditionally perfumed or flavoured, or of modifying the odour or taste of said consumer products.

Natural extracts can also be encapsulated into the system these include but are not limited to citrus extracts such as lemon, orange, lime, grapefruit or mandarin oils, or coffee, tea, cocoa, mint, vanilla or essential oils of herbs and spices, amongst other.

A nutraceutical may also be an active ingredient of the particulate composition . Nutraceuticals are compounds, ingredients or a dietary supplement or a food that has health and medical benefits, including the prevention and treatment of disease. Nutraceuticals include antioxdants, amino acids and proteins, botanicals, probiotics, nutritional fats (for example, polyunsaturated fatty acids PUFAs), soy, vitamins, and minearls. For example, the nutraceutical may be DHA, which has the beneficial effect of reducing the occurrence of cardio-vascular diseases.

Examples for whitening agents are baking soda, hydrogen peroxide and papain. Examples of antibacterials are triclosan, pyrophosphate, propolis and natural essential oils. The active ingredient may also be an ingredient for treating or preventing bad breath or breath malodour, for example green tea or parsley oil, or an antiplaque agent, for example tetra and bi-natrium, tetra and bi-potassium.

Furthermore, the active ingredient may be a mixture comprising different ingredients, for example it may be a mixture comprising different flavours. In one embodiment, the active ingredient is a mixture comprising a flavour and a nutraceutical.

In one embodiment a process provided herein comprises the steps of combining and blending the active ingredient to be encapsulated with a carrier composition comprising from 1 to 70% by weight of a first water-soluble fibrous polysaccharide having an average molecular weight higher than 10,000 Da and an average degree of polymerisation higher than 60, and from 20 and 99% of a second water-soluble fibrous polysaccharide having an average molecular weight below 10,000 Da and an average degree of polymerisation below 60, percentages being given by weight relative to the total weight of the carrier; heating said blend within a screw extruder to a temperature comprised between 80° C. and 120° C. to form a molten mass; then extruding the molten mass through a die having a die hole diameter comprised between 4 and 12 mm; and cutting the material obtained as it exits the die. Typical conditions for this process are those commonly used in the art and are well known by a skilled person, they thus do not need a more detailed description here. Specific conditions will be exemplified below.

The apparatus suitable for carrying out the process is a single or twin screw extruder. It allows to continuously mix the ingredients and subsequently extruding the composition through an extrusion die plate. The extrusion dies suitable for the use herein have hole diameters of from about 2 mm to about 12 mm, preferably from about 3 mm to about 10 mm, for example from about 4 mm to about 12 mm, generally less than 7 mm. The extruded particulate composition, due to its specific carrier composition, is subjected to a significant relaxation phenomenon at the end of the die, which allows to produce an extruded rope having a cross-sectional diameter larger than 3 mm, 4 mm, 5 mm, or 6 mm, for example, and which can be as large as about 15 mm

The process thus allows to prepare beads, preferably with a spherical shape, presenting such cross-sectional diameter, which was not possible up to now. In fact, spherical particles prepared by extrusion have already been described, but they had much smaller sizes. The spherical shape of the beads should not be intended as limiting. In fact, by varying the die shape and the moment when the extruded rope is cut, other bead shapes can be obtained by the process, for instance bean-type shapes.

The product obtained by the process is a solid particulate composition, in a glassy state. More particularly the bead has a glass transition temperature, Tg, above room temperature, namely above a temperature usually comprised between 18 and 25° C. The product is thus in a brittle form, which gives it a so-called “crunchy” character when consumed or used.

In a particular embodiment, the flavours are natural flavours.

The beads or particles provided herein are ground, particularly with a mill or grinder that may typically be used for example to grind pepper or salt directly onto a food or beverage. In a particular embodiment the grinder is a mill that is sized to be held by a human hand. In a particular embodiment, the mill has moving parts that allow the beads to be ground or crushed over a food or beverage. A flavour grinder such as a pepper mill, spice mill, or other similar device for grinding the beads comprises a movable part for example but not limited to blades for grinding flavour particles or beads provided herein. can be used to allow the pellets to be ground into a particulate flavouring. Flavour grinders provided herein may also provide a uniform turning rate via a controlled turning that controls the grinding action. This can be done mechanically by a human end or may be carried out electronically. Any device can be used that permits the beads to be ground into smaller particles that can then be applied to food product. A particular mill suitable for use for grinding beads herein is a ceramic based and adjustable CrushGrind® mill system the use of which results in a fine homogenous powder.

Particular products that may be flavoured by means of the grinding of the beads provided herein include, but are not limited, beverages such as tea, herbal tea, coffee, chocolate, juice, soda, soup (sweet or savory), syrup, cocktail, granita, milk-shake, lassi, coulis. The ground beads may be used for example, but not limited not only to flavour the food but alternatively change or reinforce the taste of a beverage, customize the taste of a beverage and to offer multiple sensations.

In another non limiting embodiment, foods such as fruits, vegetables, salad, sauce, cream, Ice cream, sorbet, yogurt, pie, glaze, whipped cream, fish (cooked, smoked, dried, pickled, marinated) seafoods, sushis, meat (cooked, smoked, dried, pickled, marinated), pasta, pizza, rice, puré(savory or sweet), butterbrot/slice of bread (savory or sweet), sandwiches, spread (savory or sweet), cheese, fondue (savory or sweet), pickles, and marinades may be flavoured, particularly at meal time. The particles may be milled over the finished food, in the cooking or serving plate or directly over each individual plate.

In one embodiment the dosage of milled product is about 0.2/g per 300 ml of a hot beverage.

In one embodiment, the particles are milled for example over a meal n a dish, with a particular dose varying from one to several turns of the mill.

Aspects of the invention will now be illustrated by way of the following examples but is not limited to these examples. Abbreviations have the meaning common in the art.

### EXAMPLES

### Example 1

Eighteen samples are prepared with the ingredients set forth in Tables 1-18 based generally on either 500 g or 1 kg amounts of flavour, between 0.16% w and 8% by weight of the total particle. The amount of lecithin was kept about 0.5% ww and the triglyceride level was adapted with the flavour load and plasticizing properties. Between 7 and 8% w of water was added to the Nutriose/Gum Arabic carrier (80/20). The samples were prepared according to the general process set forth in the examples of

US Patent U.S. Pat. No. 8,227,014, the entirety of which is incorporated by reference.

The following table summarizes the formulas of the 18 samples.

### Example 2

Milled particles were successfully tested with colourful beads of cinnamon, lime, ginger and nutmeg to produce tailor-made cola soda.

### Example 3

Milled particles were successfully tested by a Michelin chef and several diners:
Tarragon (essential oil, 0.5% load) were placed in a pepper mill and ground over each plate containing the following meal:
   Langoustines coated with “Roquette” salad, fennel and Parmesan cheese with a cocktail sorbet buratta/lime/Champagne.
   The mill was turned twice (2 times half a turn) to deliver the tarragon essential oil.

### Example 4

Milled particles were successfully tested by diners at a luncheon:
Tarragon particles (essential oil, 0.5% load) were placed in a pepper mill and ground over each plate containing the following meal:
   Fresh vegetables tartar and warm gambas with tarragon
   The mill was turned three or four times (a quarter turn) to deliver the tarragon essential oil.
Ginger particles were placed in a pepper mill and ground over each plate containing the following meal:
   Thick Cod fillet over spinach bed with a ginger coulis
   The mill was turned three or four times (a quarter turn) to deliver the ginger essential oil.
Chai Tea flavour particles were placed in a pepper mill and grinded over each plate containing the following dessert:
   Pannacotta with mango and orange salad
   The mill was turned twice (a quarter turn) to deliver the chai tea flavour.

### Example 5

Milled particles were successfully tested by diners at a luncheon:
Lemon (blend essential oils and essences, 5% load) were placed in a pepper mill and ground over each plate containing the following meal:
   Duo of fresh and smoked salmon with dill and small crunchy salad
   The mill was turned three times (a quarter turn) to deliver the lemon flavour.
Cardamom flavour particles were placed in a pepper mill and ground over each plate containing the following meal:
   Chicken supreme in Tajine with cardamom flavour
   The mill was turned three times (a quarter turn) to deliver the cardamom flavour.
Orange Blossom flavour were placed in a pepper mill and ground over each plate containing the following dessert:
   Mango salad and its sorbet with orange blossom flavour
   The mill was turned twice (a quarter turn) to deliver the orange blossom flavour.

### Example 6

Lemon particles were prepared and milled and the release of the flavour was measured against particle size. The results are displayed in FIG. 2.

1. A method of flavouring food comprising grinding a particle on top of a food or beverage contemporaneous with the use of the food or beverage, wherein the particle is in the form of an extruded, glassy bead, comprising a fibrous carrier composition encapsulating a flavour ingredient or composition active ingredient, characterised in that the bead has a cross-section diameter comprised between 3 mm and 15 mm, and the carrier composition comprises from 2 to 90% by weight of a first water-soluble fibrous polysaccharide having an average molecular weight higher than 10000 Dalton and an average degree of polymerisation higher than 60, and from 1 to 80% of a second water-soluble fibrous polysaccharide having an average molecular weight below 10000 Dalton and an average degree of polymerisation below 60, said percentages being defined by weight relative to the total weight of the carrier composition.

2. The method as recited in claim 1 wherein he bead has a cross-section diameter comprised between 5 mm and 15 mm.

3. The method as recited in claim 1 wherein, the carrier composition is sugarless and/or non-cariogenic.

4. A food mill comprising an extruded, glassy bead, comprising a fibrous cattier composition encapsulating a flavour ingredient or composition active ingredient, characterised in that the bead has a cross-section diameter comprised between 3 mm and 15 mm, and the carrier composition comprises from 2 to 90% by weight of a first water-soluble fibrous polysaccharide having an average molecular weight higher than 10000 Dalton and an average degree of polymerisation higher than 60, and from 1 to 80% of a second water-soluble fibrous polysaccharide having an average molecular weight below 10000 Dalton and an average degree of polymerisation below 60, said percentages being defined by weight relative to the total weight of the carrier composition wherein the food mill or grinder is of a size that allows it to be held by a human hand such that the human may flavour a food or beverage by using the mill to grid the bead onto said food or beverage prior to or contemporaneous with the use of the food or beverage.

5. The mill as recited in claim 4 wherein the bead comprises from 0.01 to 15% by weight of active ingredient relative to the total weight of the composition.

6. A particulate composition according to claim 4, characterised in that the first water-soluble fibrous polysaccharide is selected from the group consisting of konjac mannan, xanthan, gum Arabic, guar gum, pectin, locus bean gum, soluble soyahean polysaccharide and beta-glucan.

7. A particulate composition according to claim 1, characterised in that the second water-soluble fibrous polysaccharide is a dextrin.
